(19) United States
(12) Patent Application Publication
(10) Pub. No.: US 2025/0356262 A1
(43) Pub. Date: Nov. 20, 2025

(54) Superfast Selection for Decision Tree Algorithms

(71) Applicant: Board of Regents, The University of Texas System, Austin, TX (US)

(72) Inventors: Huaduo Wang, Richardson, TX (US); Gopal Gupta, Plano, TX (US)

(21) Appl. No.: 19/208,002

(22) Filed: May 14, 2025

Related U.S. Application Data
(60) Provisional application No. 63/649,643, filed on May 20, 2024.

(51) Int. Cl. G06N 20/00

(52) U.S. Cl. CPC G06N 20/00

(57) ABSTRACT

A method of decision tree split selection is provided. The method comprises scanning, in a data source, all values of a feature and example labels. Intermediate statistics information of size O(N×C) are prepared, wherein N is the number of unique values of the feature and C is the number of label classes. A set of the N unique values of the feature are prepared with time cost O(N×C). The process then loops N times to compute heuristic scores for all splits of each unique value. Each loop has a time cost O(C). The time complexity of decision tree split selection for a single feature is O(M+N×C), wherein M is the number of examples of the feature. A model is trained in real-time with decision tree splits selected according to the heuristic scores.

### CROSS-REFERENCE TO RELATED APPLICATION

This application claims priority to U.S. Provisional Application 63/649,643, filed May 20, 2024, the entirety of which is hereby incorporated by reference in its entirely.

### STATEMENT OF GOVERNMENT SUPPORT

This invention was made with government support under grant no. 1910131 awarded by the National Science Foundation. The Government has certain rights in this invention.

### BACKGROUND INFORMATION

### 1. Field

The present invention relates in general to artificial intelligence, and more specifically to an improved decision tree selection algorithm.

### 2. Background

In the rapidly evolving field of machine learning, recent research trends have shown a marked inclination towards developing complex models and tackling sophisticated tasks, exemplified by the surge in interest around large-scale models and generalized artificial intelligence. These advancements represent significant milestones, showcasing the field's capacity for innovation and its relentless pursuit of cutting-edge technology. However, it is crucial to acknowledge that the backbone of machine learning applications in real-world scenarios remains rooted in more lightweight and straightforward models. Despite the allure of complexity and the push towards increasingly elaborate systems, a substantial portion of machine learning tasks today can be effectively addressed using simpler, more efficient models. These models not only offer practical solutions to a wide array of problems but also underscore the importance of accessibility, interpretability, and computational efficiency in the vast landscape of machine learning. This dichotomy between the pursuit of advanced research frontiers and the practical necessities of everyday applications highlights a balanced ecosystem within the field, where innovation and applicability stride hand in hand.

In the domain of machine learning, decision tree algorithms stand out for their simplicity and interpretability, making them a staple in both academic research and practical applications. However, as the volume and complexity of data continue to grow, optimizing these algorithms for enhanced efficiency, accuracy, and scalability becomes increasingly vital. This necessity has spurred the development of a variety of optimization techniques, aimed at refining every aspect of decision tree learning—from the construction phase to the model's final deployment. Techniques such as pruning, which simplifies the model to mitigate overfitting, feature selection, and tree ensemble methods which hones in on the most relevant data, are instrumental in improving the performance of decision trees. Furthermore, advancements in splitting criteria, parallel and distributed computing, and incremental learning adapt these algorithms for the demands of large-scale data analysis, ensuring their continued relevance in the fast-evolving landscape of machine learning.

Split selection is a fundamental aspect of training decision tree algorithms. It involves choosing the optimal value and feature to divide the data at each node of the tree. This process is crucial for effectively building the tree's structure, which is aimed at solving classification or regression problems by learning simple decision rules inferred from the training data. Most of the research in this field is about heuristic metrics that guide selection choices. The generic approach to selecting splits involves comprehensively calculating the heuristic scores for all candidate splits and then choosing the one with the highest score. However, this method of selection within decision tree algorithms constrains the model's training due to its time complexity, which is quadratic relative to the number of training instances. The research field of systematically computing the heuristic scores still remains under-explored.

Therefore, it would be desirable to have an apparatus and system that take into account at least some of the issues discussed above, as well as other possible issues.

### SUMMARY

An illustrative embodiment provides a computer-implemented method of decision tree split selection. The method comprises scanning, in a data source, all values of a feature and example labels. Intermediate statistics information of size O(N×C) are prepared, wherein N is the number of unique values of the feature and C is the number of label classes. A set of the N unique values of the feature are prepared with time cost O(N×C). The process then loops N times to compute heuristic scores for all splits of each unique value. Each loop has a time cost O(C). The time complexity of decision tree split selection for a single feature is O(M+N×C), wherein M is the number of examples of the feature. A model is trained in real-time with decision tree splits selected according to the heuristic scores. According to other illustrative embodiments, a computer system and a computer program product for decision tree split selection are provided.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 illustrates an algorithm for generic split selection;

FIG. 2 illustrates an algorithm for superfast selection;

FIG. 3 depicts a table comparing numerical and categorical values;

FIG. 4 illustrates an algorithm for an algorithm for a simplified information gain function;

FIG. 5 depicts a table of attribute values;

FIGS. 6A and 6B illustrate an algorithm for a best split function;

FIG. 7 illustrates an ultrafast tree of decision algorithm;

FIG. 8 depicts a table of heuristic values of given people;

FIG. 9 depicts a table of time cost comparison of generic and superfast selection;

FIG. 10 depicts a table of CART with superfast selection on various datasets;

FIG. 11 illustrates an algorithm for a numerical label selection function;

FIG. 12 illustrates an algorithm for an ultrafast tree of decision predict function;

FIG. 13 depicts a graph comparing generic and superfast selection; and

FIG. 14 depicts a flowchart illustrating a method for decision tree split selection in accordance with an illustrative embodiment; and

FIG. 15 depicts a flowchart illustrating a method for scanning the values of the feature and example labels in accordance with an illustrative embodiment.

### DETAILED DESCRIPTION

The illustrative embodiments provide a novel selection algorithm—Superfast Selection—to compute the heuristic score of all possible candidate splits and make selection systematically. Superfast Selection algorithm speeds up the decision tree training process by reducing the time complexity of the split selection process. We enhance CART (classification and regression tree) algorithm by integrating Superfast Selection and Training Only Once Tuning to develop Ultrafast Tree of Decision, demonstrating the potency of Superfast Selection.

Selection is a step in the decision tree machine learning algorithm. We have designed a new method for selection that we call Superfast Selection Method that results in orders of magnitude improvement in execution time performance as well as memory performance. Since the decision tree algorithm with the Superfast Selection Method learns patterns in data significantly faster, using less memory. Therefore, it can handle very large datasets. The decision tree algorithm with superfast selection, therefore, possesses several advantages.

Superfast Selection speeds up current applications of decision tree algorithms and enables them to handle much larger datasets. This results in reduced operation costs in time, money, energy, and the cost of purchasing devices for more computational resources.

Superfast Selection allows “resource-constrained devices” like wearable devices, IoT (Internet of Things) devices and mobile phones to have the ability to train machine learning models. IoT devices can learn from data and make immediate decisions without needing to send data to servers or cloud for processing. This would reduce latency in decision making processes (crucial for applications requiring instant response such as autonomous vehicles and real-time monitoring systems) and increase autonomy in devices with the ability to train model instantly. IoT devices could particularly benefit in remote or extreme environments without network or human intervention, like deep-sea sensors or rovers.

The instant learning ability allows for decision trees to be used in environments that demand real-time performance, like financial markets. It can be used to instantly adjust pricing models based on the real-time market demand, competitor pricing, and inventory levels. Instant training would allow for immediate reaction to market changes, maximizing profitability and market competitiveness.

Split selection in a decision tree is governed by specific criteria meant to maximize the homogeneity of the resultant subsets after the splits. Different algorithms may use different metrics for this purpose. The primary goal is to make decisions at each node that best separates the data into classes (for classification tasks) or minimize variance (for regression tasks). A split selection process of a single tree node typically works as follows:
For each candidate feature, find all potential splits. For categorical features, this might involve grouping categories together, while for numerical features, this involves finding thresholds.
Calculate the chosen metric (like Gini Impurity, Information Gain, variance, etc.) for each possible split.
Select the split that results in the highest score of the chosen metric.

Superfast Selection is an algorithm framework that is compatible with the most commonly used split criteria, like Gini Impurity, Information Gain, Chi-Square, and variance (for regression tasks).

Incorporating the Superfast Selection method in a decision tree machine learning system, where the dataset being processed has at least one numerical feature, produces the technical effect of at least 1000 times improvement in execution time (observed experimentally for a large number of datasets) and at least 1000 times improvement in memory consumption (observed experimentally for a large number of datasets) compared to current state-of-the-art decision tree machine learning systems.

The most common data a decision tree deals with is tabular data, and the input features generally fall into two categories: numerical features and categorical features. Superfast Split Selection can deal with both numerical and categorical features as well as hybrid features (a feature that contains both numerical values and categorical values simultaneously) without the need for any pre-encoding such as one-hot encoding or integer encoding.

The generic split selection described here is a general abstraction of the widely used split selection process. The high-level generic split selection algorithm and Superfast selection algorithm on a single feature are summarized as Algorithm 1 and Algorithm 2, respectively. In Algorithms 1 and 2, M is the number of examples, N is the number of unique values of the feature, and C is the number of label classes.

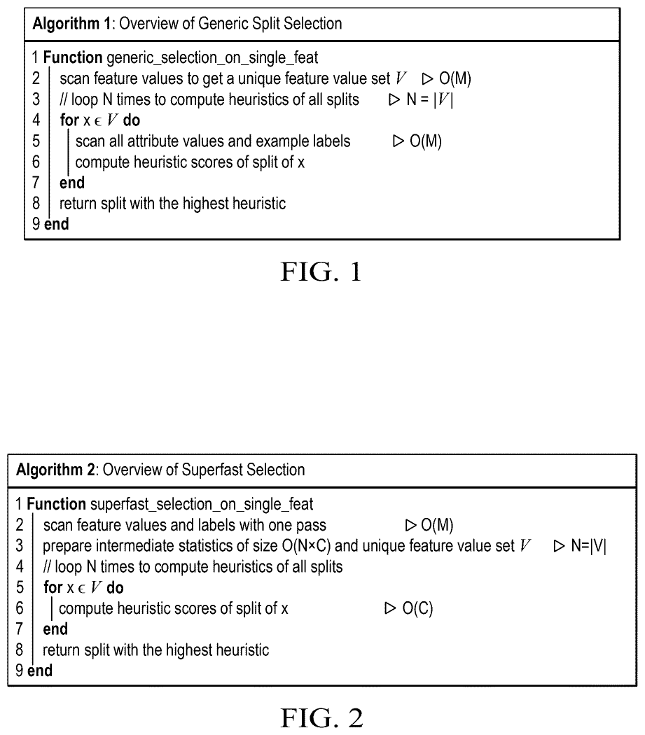

In Algorithm 1 shown in FIG. 1, the generic selection algorithm first collects the unique value set of the feature with O(M) time cost then loops N times to compute the heuristic scores of all splits. Inside each loop, the algorithm scans all values of the feature and example labels with O(M) time cost and then computes the heuristic score. Therefore, the time complexity of generic split selection on a single feature is O(M×N).

In Algorithm 2 shown in FIG. 2, the Superfast Selection Algorithm first scans all values of the feature and example labels and prepares intermediate statistics information of size O(N×C) and the unique value set of the feature with time cost O(N×C). Then, the algorithm loops N times to compute the heuristic scores of all splits of each unique value. Inside each loop, it only needs O(C) time cost to compute the heuristic of all splits of this value by using the intermediate statistics. Therefore, the time complexity of Superfast Selection on a single feature is O(M+N×C). Generally, the number of label classes C is considered a constant number. In this case, the complexity can be simplified as O(M). In contrast, the time complexity of the generic split selection is O(M×N).

Missing data is so common that it is the norm rather than an exception. There are many ways to deal with the missing values that have been suggested:
removing the rows/columns.
imputation that replaces missing values with mean, median, or mode of observed values in that column.
predicting the missing value with machine learning or data mining techniques using the training data.

However, these methods essentially change the original data by either adding extra information or discarding defective samples. To keep the algorithm simple and data authenticity, Superfast Selection deals with missing values by leaving them untouched without losing or adding any information.

The generic split selection procedure generates numerical comparison (“≤” and “>”) splits for numerical features and generates equality (“=” and “/=”) comparison splits for categorical features. Superfast Selection algorithm handles all the values of a categorical feature as categorical values, same as generic split selection. To deal with hybrid features, Superfast Selection tries to read each value of a numerical or hybrid feature as a number first, converting it to a categorical value if the conversion fails. A categorical feature may use numbers as categories, in which case these numbers will not be read as numerical values, rather as categories. Numerical comparison (“≤” and “>”) split candidates would be generated for each numerical value, and equality comparison (“=” and “/=”) split candidates would be generated for each categorical value. In this way, Superfast Selection algorithm enumerates all the values in the features and then exhaustively computes their heuristic scores.

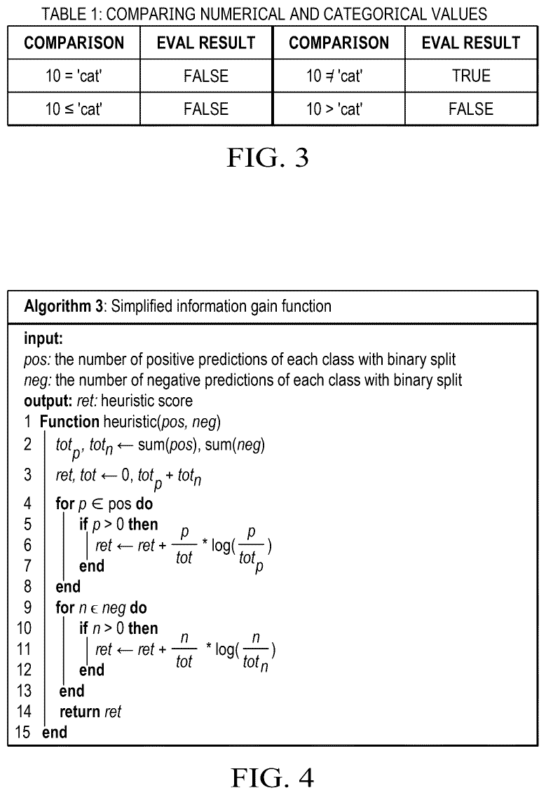

Superfast Selection algorithm employs a carefully designed comparison operator that can directly handle hybrid features without pre-encoding such as one-hot encoding or integer encoding. Equality of two same-type values (categorical or numerical) is straightforward as commonsense dictates: they are equal if they are identical, otherwise, they are unequal. The equality of different types of values is always false, therefore their inequality is always true. The numerical comparison between a categorical value and a numerical value is always false. Table 1 in FIG. 3 shows the evaluations of different comparisons between 10 and ‘cat’.

Superfast Selection algorithm utilizes the prefix-sum technique to speed up the heuristic computing process of a feature. The carefully designed comparison operator is a prerequisite for using the prefix-sum technique. Because it makes all evaluation results of split candidates fall into only two sets (positive and negative) in a consolidated way.

Here we use Information Gain as an example heuristic to show how Superfast Selection works, while other heuristics, like Gini Index, Gini Impurity, and Chi-Square, can also be integrated into the Superfast Selection:

$$IG ( T , a ) = H ( T ) - H ( T \vert a ) \qquad ( 1 )$$

where H(T) is the entropy of the training set T while H(T|a) is the cross-entropy of the training set on attribute a. In practice, H(T) can be ignored for comparison because all the candidates would have the same entropy value. Therefore, only H(T|a) is needed for comparison. Then the information gain computation for comparison is simplified as:

$$\frac{1}{M} {\sum }_{i = 1}^{C} {( {p}_{i} \cdot log \frac{{p}_{i}}{{\sum }_{j = 1}^{c} {p}_{j}} )}_{{p}_{i} > 0} + \frac{1}{M} {\sum }_{i = 1}^{C} {( {n}_{i} \cdot log \frac{{n}_{i}}{{\sum }_{j = 1}^{c} {n}_{j}} )}_{{n}_{i} > 0} \qquad ( 2 )$$

where pᵢ, nᵢ denotes the number of positive predictions and the number of negative predictions for the examples of classᵢ with binary splitting respectively. c denotes the number of label classes, and M denotes the number of examples. In Superfast Selection, this equation costs O(C) time to compute.

Equation 2 can be realized as the heuristic function in Algorithm 3 shown in FIG. 4. Based on the above simplified heuristic function, the Superfast Selection can be summarized as the best_split_on_feat function in Algorithm 4. In lines 2-9, the function initializes a statistics-collecting process for heuristic calculation. After gathering all statistics, the function calculates the prefix sum in lines 10-14. In lines 15-36, the function systematically computes the heuristic score for all the possible split candidate predicates. Finally, the result is the best score with its corresponding split.

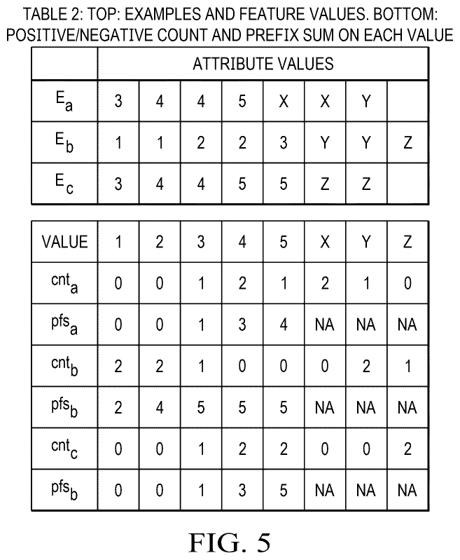

Here is an example of the heuristic calculation process in Table 2 shown in FIG. 5: there are 7 examples with the label “a”, 8 examples with the label “b”, and 7 examples with the label “c”. Their attribute values are listed in the top table. Their corresponding count cntx and prefix sum pfsx in Table 2 have been computed as lines 2-9 in Algorithm 4. Then, the heuristic scores of all possible split predicates in Table 2 have been calculated as lines 15−36. Finally, −0.87 with val≤2 is returned as the result of the best_split_on_attr function.

A common method to reduce the computational cost for split selection is to reduce the number of split candidates based on the distribution of feature values. Instead, Superfast Selection algorithm computes the heuristic scores of all possible splits of a given feature. In Algorithm 2, Superfast Selection costs O(N×C) time to prepare the intermediate statistics and costs the same O(N×C) time to compute all the heuristic scores. Reducing the number of candidate splits will not help reduce the time complexity for Superfast Selection.

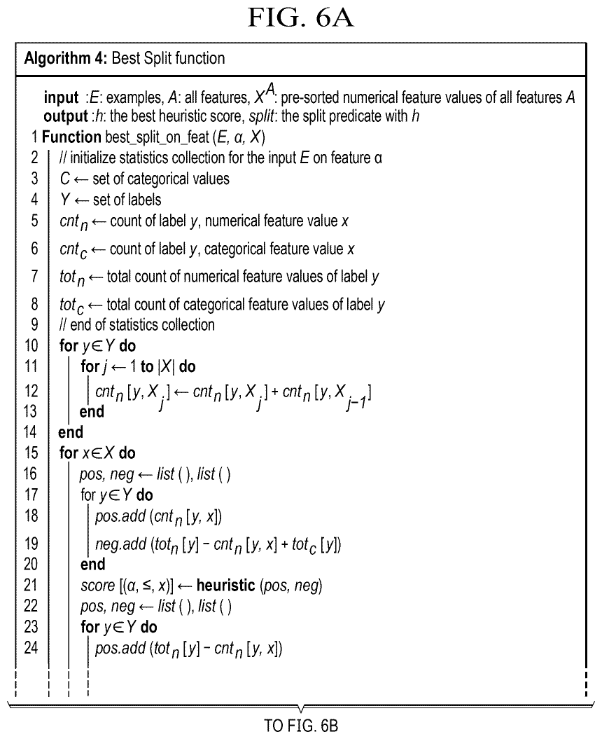

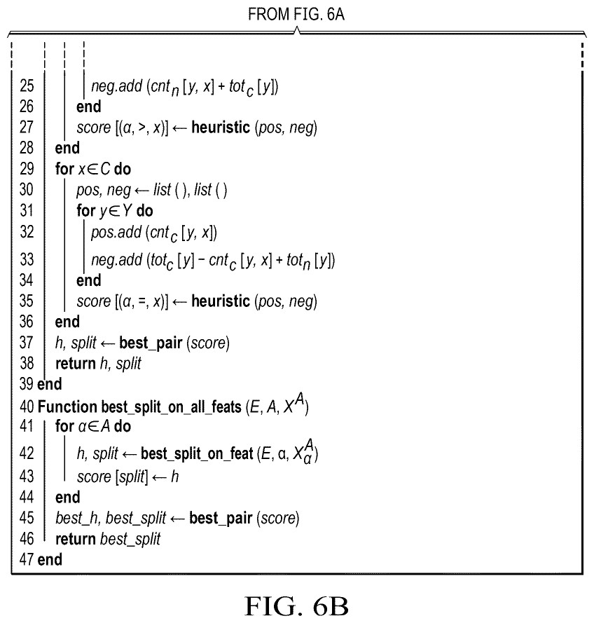

As mentioned above, the time complexity of Superfast Selection on a single attribute is O(M+N×C) and can be simplified in practice to O(M). However, the best_split_on_feat function in Algorithm 4 shown in FIGS. 6A and 6B takes a pre-sorted number list as an input parameter. Typically, the sorting process of a set of numbers with size O(M) cannot be finished within O(M) time. But the sorting cost can be shared across the whole process of building the decision tree and the numbers only need to be sorted once at the beginning. The overhead of preparing the sorted numbers for each split selection process is to maintain a list of sorted present numbers and filter out the split-out numbers during the node-splitting process which costs O(M) time in total.

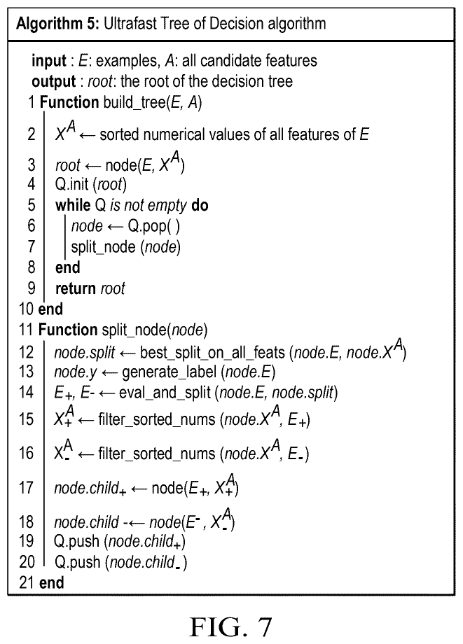

Classification and regression tree (CART) is a good example to illustrate the power of Superfast selection. We assume readers are already familiar with the CART algorithm since it is well-known and widely used. Ultrafast Tree of Decision is summarized in Algorithm 5 in FIG. 7. To optimally apply the Superfast selection algorithm on the UTD, all numerical values of each feature are sorted at the initial stage of the tree-building process in line 2. In the node-splitting process, to maintain the sorted feature values, a hash table does help to identify if a value appears in a child node for each feature. In line 15-16, the function filter_sorted_nums filters out the numerical values that are not included in node.X^{A} for each feature. The sorted feature values node.X^{A} have been divided into

$${X}_{+}^{A} and {A}_{-}^{A}$$

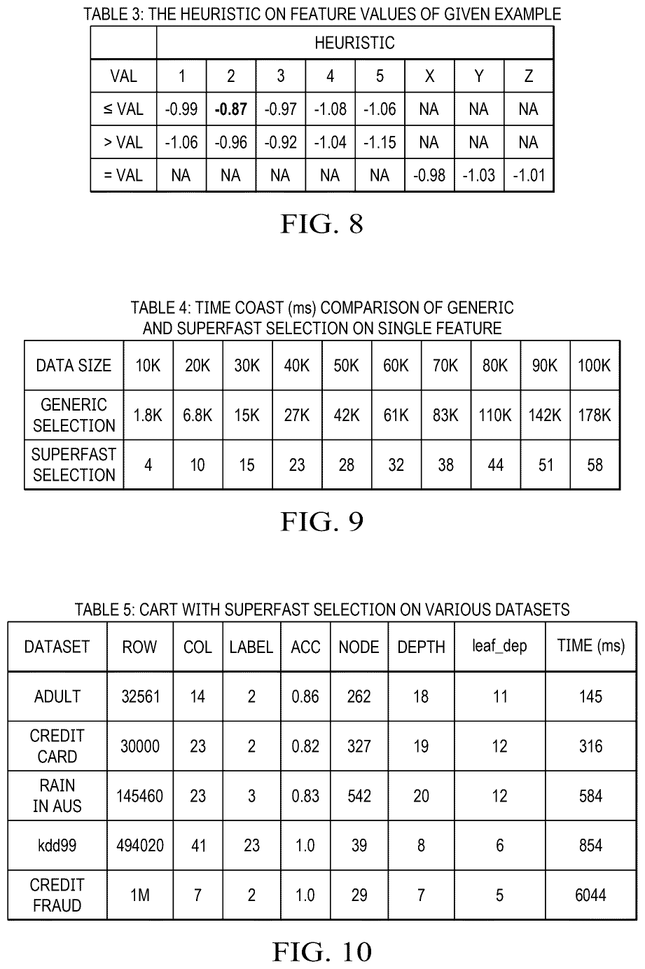

based on the evaluation of examples. In this way, the cost of sorting numerical values is distributed across the whole tree-building process. Table 3 in FIG. 8 lists heuristic values of given people.

CART uses the sum of square error (SSE) as the criterion of label splitting with numerical values:

$$SSE = {\sum }_{i ϵ {S}_{1}} {y}_{i}^{2} + {\sum }_{i ϵ {S}_{2}} {y}_{i}^{2} - \frac{1}{\vert {S}_{1} \vert} {( {\sum }_{i ϵ {S}_{1}} {y}_{i} )}^{2} - \frac{1}{\vert {S}_{2} \vert} {( {\sum }_{i ϵ {S}_{2}} {y}_{i} )}^{2} \qquad ( 3 )$$

In the above formula, S₁ and S₂ are the two label sets the split creates.

$${\sum }_{i ϵ {S}_{1}} {y}_{i}^{2} + {\sum }_{i ϵ {S}_{2}} {y}_{i}^{2}$$

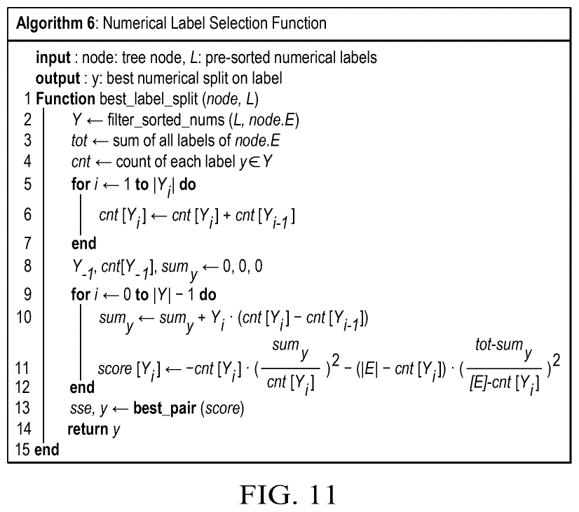

can be ignored for the same label set due to having the same value. Then, numerical label selection can be optimized with prefix-sum as in Algorithm 6 in FIG. 11. If the number of examples is M, the complexity of finding the best split for the label is O(M). Note the number of classes in the split selection process is always two, the overhead of splitting the label will not add extra cost to the time complexity of the tree-building process.

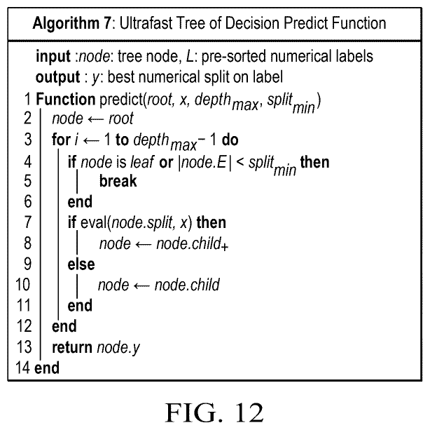

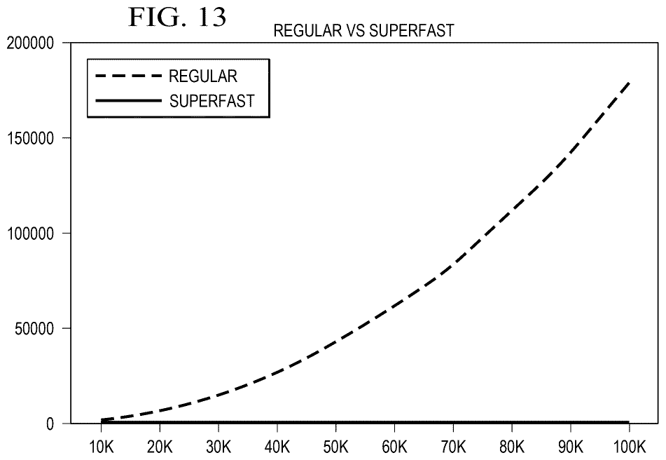

Decision tree models, while highly intuitive and interpretable, are particularly prone to overfitting on the training set. This susceptibility origins from the inherent flexibility and ability to create complex decision boundaries that perfectly classify the training data. Many hyper-parameters are used for tuning decision tree models to mitigate overfitting, the most commonly used are “Maximum Depth”, “Minimum Samples Split”, and “Maximum Features”. Ultrafast Tree of Decision algorithm currently employs “Maximum Depth” and “Minimum Samples Split” as the criteria for tuning the model. With these two hyper-parameters, it is not necessary to train multiple times for tuning models with different parameters, since the tree would be built with exactly the same pattern if training data and candidate features were not changed. The training process of UTD also determines the label of each node in the node-splitting phase. After training a full/pre-tuned decision tree, the hyper-parameters would be used in the “predict” function of Algorithm 7 in FIG. 12 to return results on non-leaf nodes during the tuning process. Finally, the tree model will be pruned based on the optimal evaluation result among all hyper-parameter settings.

In the worst-case scenario for constructing a binary decision tree, the outcome is a balanced binary tree. The sorting of numerical values for K candidate features can be completed in O(KM log M) time, and the results can be reused throughout the entire tree-building process. The time complexity for building this tree is O(KM log M), given that there are K candidate features and the cost for selecting a split on a single feature is O(M). Therefore, the Ultrafast Tree of Decision algorithm powered by Superfast Selection can build decision trees within O(KM log M) time in total.

We next report on experiments that we conducted with Superfast selection algorithm and Ultrafast Tree of Decision algorithm. First, we compare Superfast Selection algorithm with the generic selection method on a single feature. In the comparison experiment, we performed two selection algorithms on the “credit_card_fraud” dataset which contains 1 million samples with 7 attributes. The algorithm is implemented in C++ and the testing machine is a Macbook Air M2 silicon with 8 GB memory. We performed each selection algorithm 10 times on a single feature with different sizes that range from 10K to 10K then reported the average time cost for each size in Table 4 shown in FIG. 9.

Next, we present the performance results of Ultrafast Tree of Decision on five popular datasets of varying sizes. The major purpose of Superfast Selection is to speed up the training process rather than improve the model for better accuracy. We simply set two hyper-parameters max_depth as 20 and min split as 0.05% of the size of the training set. We treat 80% of the data as training examples and 20% as testing examples. We performed 10 cross-validation tests on 5 different datasets and reported the average values of training time, accuracies, numbers of nodes, depths, and average leaf depth in Table 5 shown in FIG. 10.

FIG. 13 depicts a graph comparing generic and superfast selection. The Y axis represents time, and the X axis represents the problem size.

Numerous optimization strategies have been designed to enhance every facet of decision tree learning, from initial construction to ultimate deployment. Methods like pruning, which streamlines the model to avert overfitting, and feature selection, focusing on the most pertinent data, are crucial for boosting decision tree performance. Moreover, progress in defining splitting criteria, along with the adoption of parallel and distributed computing, as well as incremental learning techniques, tailor these algorithms to meet the requirements of analyzing vast datasets, securing their ongoing significance in the rapidly advancing field of machine learning. These optimization strategies have the potential to accelerate the training process by one to two orders of magnitude. However, our newly created Superfast Selection enhances the training procedure by reducing its time complexity. In addition, Superfast Selection empowered UTD (Ultrafast Tree of Decision) to handle hybrid features in a consolidated way without generic pre-encoding.

As explained above, the illustrative embodiments provide a highly efficient systematic method of selecting the “optimal split” for decision tree algorithms, called Superfast Selection. Superfast Selection employs the prefix-sum technique to speed up the split selection on a single feature from O(MN) to O(M) (M is the number of examples, and N is the number of unique feature values). Additionally, we experimented with Ultrafast Tree of Decision (Superfast Selection powered CART algorithm) with an O(KM²) (K is the number of features) time complexity training cost. The result shows that even a lightweight laptop can finish training with UTD on datasets with millions of examples in seconds. Superfast Selection does not serve as a substitute for any of the existing optimizations; rather, it represents a significant enhancement in a relatively unexplored area. It can further augment the performance of decision tree algorithms alongside existing optimizations.

From wearable gadgets and IoT devices to vehicle infotainment systems and web services, the application of Superfast Selection can significantly enhance efficiency and energy conservation. By embedding this computational capability into less resource-intensive devices, we not only unlock the potential for smarter, more responsive technology but also pave the way for a new era of innovation. This advancement in learning ability for lightweight devices promises to redefine their role in our daily lives. The potential of Superfast Selection to integrate seamlessly into everyday gadgets and services underscores a shift towards a more intelligently connected world.

The decision tree algorithm with Superfast Selection, Ultrafast Decision Tree, possesses several advantages: 1) it speeds up current applications of decision tree algorithms, and enables them to handle much larger datasets. This effect results in reduced operation costs in time, money, energy, and the cost of purchasing devices for more computational resources; 2) it allows “resource-constrained devices” like wearable devices, IoT devices, and mobile phones to have the ability to train machine learning models much more efficiently. IoT devices can learn from data and make immediate decisions without needing to send data to servers or cloud for processing. This would reduce latency in decision-making processes (crucial for applications requiring instant response such as autonomous vehicles and real-time monitoring systems) and increase autonomy in devices with the ability to train models instantly. IoT devices could particularly benefit in remote or extreme environments without network or human intervention, like deep-sea sensors or rovers; 3) the instant learning ability allows for decision trees to be used in environments that demand real-time performance, like financial markets. It can be used to instantly adjust pricing models based on real-time market demand, competitor pricing, and inventory levels. Instant training would allow for immediate reaction to market changes, maximizing profitability and market competitiveness.

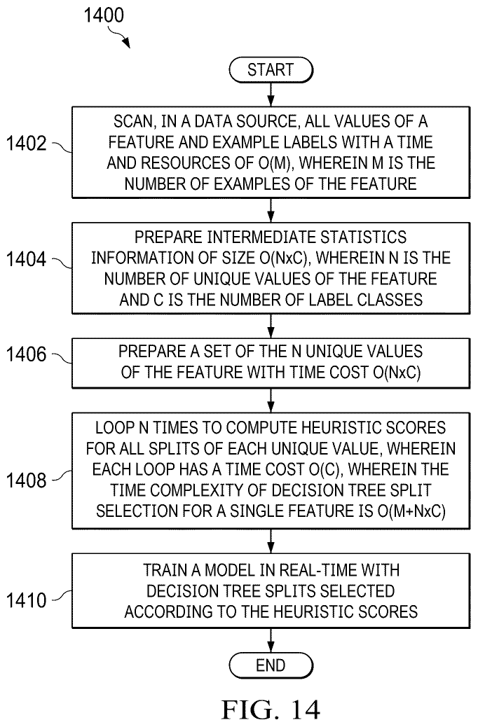

FIG. 14 depicts a flowchart illustrating a method for decision tree split selection in accordance with an illustrative embodiment. Process 1400 begins by scanning, in a data source, all values of a feature and example labels with a time and resources of O(M), wherein M is the number of examples of the feature (step 1402). The feature may comprise numerical data, categorical data, or a hybrid of numerical and categorical data.

Process 1400 then prepares intermediate statistics information of size O(N×C), wherein N is the number of unique values of the feature and C is the number of label classes (step 1404).

Process 1400 prepares a set of the N unique values of the feature with time cost O(N×C) (step 1406) and loops N times to compute heuristic scores for all splits of each unique value (step 1408). Each loop has a time cost O(C), wherein the time complexity of decision tree split selection for a single feature is O(M+N×C).

A model is then trained in real-time with decision tree splits selected according to the heuristic scores (step 1410). The decision tree splits with the highest heuristic scores are selected for training the model. Process 1400 then ends.

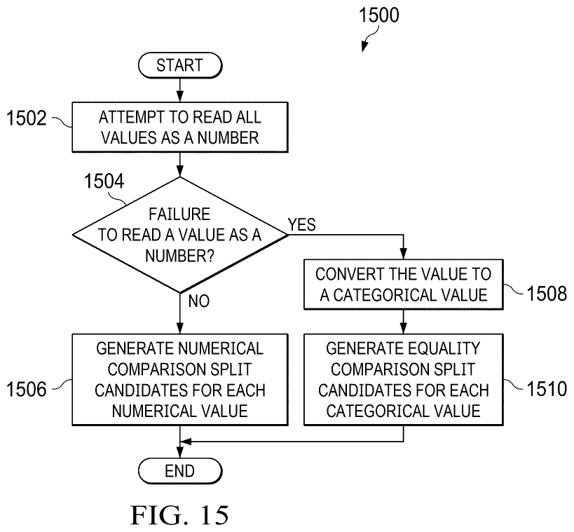

FIG. 15 depicts a flowchart illustrating a method for scanning the values of the feature and example labels in accordance with an illustrative embodiment. Process 1500 is a detailed example of step 1402 in FIG. 14 for cases when the feature comprises a hybrid of numerical and categorical data.

Process 1500 begins by attempting to read all values as a number first (step 1502). Responsive to success in reading a value as a number (step 1504), process 1500 generates numerical comparison split candidates for each numerical value (step 1506).

Responsive to a failure to read a value as a number, process 1500 converts the value to a categorical value (step 1508) and generates equality comparison split candidates for each categorical value (step 1510).

Process 1500 then ends.

The illustrative embodiments may be carried out as a computer-implemented method. The illustrative embodiments may be implemented as a system comprising a storage device that stores program instructions one or more processors operably connected to the storage device and configured to execute the program instructions to cause the system to perform the steps of processes 1400 and 1500. The illustrative embodiments may also be implemented as a computer program product comprising a persistent storage medium having program instructions configured to cause one or more processors to perform the steps of processes 1400 and 1500.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The descriptions of the various embodiments of the present invention have been presented for purposes of illustration, but are not intended to be exhaustive nor is the present invention limited to the embodiments disclosed. Many modifications and variations will be apparent to those of ordinary skill in the art without departing from the scope and spirit of the described embodiment. The terminology used herein was chosen to best explain the principles of the embodiments, the practical application or technical improvement over technologies found in the marketplace, or to enable others of ordinary skill in the art to understand the embodiments disclosed here.

Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method of decision tree split selection, the method comprising:
scanning, in a data source, all values of a feature and example labels with a time and resources of O(M), wherein M is the number of examples of the feature;
preparing intermediate statistics information of size O(N×C), wherein N is the number of unique values of the feature and C is the number of label classes;
preparing a set of the N unique values of the feature with time cost O(N×C);
looping N times to compute heuristic scores for all splits of each unique value, wherein each loop has a time cost O(C), wherein the time complexity of decision tree split selection for a single feature is O(M+N×C); and
training a model in real-time with decision tree splits selected according to the heuristic scores.

2. The method of claim 1, wherein the feature comprises numerical data.

3. The method of claim 1, wherein the feature comprises categorical data.

4. The method of claim 1, wherein the feature comprises a hybrid of numerical and categorical data.

5. The method of claim 4, wherein scanning the values of the feature and example labels further comprises:
attempting to read all values as a number first; and
responsive to a failure to read a value as a number, converting the value to a categorical value.

6. The method of claim 4, further comprising generating numerical comparison split candidates for each numerical value.

7. The method of claim 4, further comprising generating equality comparison split candidates for each categorical value.

8. The method of claim 1, wherein the decision tree splits with the highest heuristic scores are selected.

9. A system for decision tree split selection, the system comprising:
a storage device that stores program instructions;
one or more processors operably connected to the storage device and configured to execute the program instructions to cause the system to:
scan, in a data source, all values of a feature and example labels with a time and resources of O(M), wherein M is the number of examples of the feature;
prepare intermediate statistics information of size O(N×C), wherein N is the number of unique values of the feature and C is the number of label classes;
prepare a set of the N unique values of the feature with time cost O(N×C);
loop N times to compute heuristic scores for all splits of each unique value, wherein each loop has a time cost O(C), wherein the time complexity of decision tree split selection for a single feature is O(M+N×C); and
train a model in real-time with decision tree splits selected according to the heuristic scores.

10. The system of claim 9, wherein the feature comprises numerical data.

11. The system of claim 9, wherein the feature comprises categorical data.

12. The system of claim 9, wherein the feature comprises a hybrid of numerical and categorical data.

13. The system of claim 12, wherein, to scan the values of the feature and example labels, the processors further execute program instructions to:
attempt to read all values as a number first; and
responsive to a failure to read a value as a number, convert the value to a categorical value.

14. The system of claim 13, wherein the processors further execute program instructions to generate numerical comparison split candidates for each numerical value.

15. The system of claim 13, wherein the processors further execute program instructions to generate equality comparison split candidates for each categorical value.

16. The system of claim 9, wherein the decision tree splits with the highest heuristic scores are selected.

17. A computer program product for decision tree split selection, the computer program product comprising:
a persistent storage medium having program instructions configured to cause one or more processors to:
scan, in a data source, all values of a feature and example labels with a time and resources of O(M), wherein M is the number of examples of the feature;
prepare intermediate statistics information of size O(N×C), wherein N is the number of unique values of the feature and C is the number of label classes;
prepare a set of the N unique values of the feature with time cost O(N×C);
loop N times to compute heuristic scores for all splits of each unique value, wherein each loop has a time cost O(C), wherein the time complexity of decision tree split selection for a single feature is O(M+N×C); and
train a model in real-time with decision tree splits selected according to the heuristic scores.

18. The computer program product of claim 17, wherein the feature comprises one of:
numerical data;
categorical data; or
a hybrid of numerical and categorical data.

19. The computer program product of claim 18, wherein, for a hybrid of numerical and categorical data, scanning the values of the feature and example labels further comprises instructions for:
attempting to read all values as a number first;
generating numerical comparison split candidates for each numerical value; and
responsive to a failure to read a value as a number, converting the value to a categorical value and generating equality comparison split candidates for each categorical value.

20. The computer program product of claim 17, wherein the decision tree splits with the highest heuristic scores are selected.
